(19) United States
(12) Patent Application Publication
(10) Pub. No.: US 2003/0071787 A1
(43) Pub. Date: Apr. 17, 2003

(54) Foot actuated computer mouse adaptor and electronic modular adaptor

(76) Inventor: Stuart Thomas Gerstacker, Austin, TX (US)

Correspondence Address: Stuart T. Gerstacker, 11703 Ruffed Grouse Drive, Austin, TX, 78758, US

(21) Appl. No.: 09/976,870

(22) Filed: Oct. 12, 2001

(51) Int. Cl. G09G 5/08

(52) U.S. Cl. 345/163

(57) ABSTRACT

A foot actuated computer mouse adaptor for operating a conventional computer mouse with a computer user's foot, used individually or in conjunction with one or more modular electronic adaptors that allow simultaneous use of additional conventional computer mice to drive a single cursor or multiple cursors. The foot actuated computer mouse adaptor allows a computer user to move and actuate the buttons of a conventional computer mouse via movement of one of the user's feet on any substantially flat surface. Simultaneous actuation of two or more conventional computer mice is achieved with an electronic modular adaptor that accepts input from each individual mouse and combines the two inputs to produce a single output. This single output can then be plugged directly into a computer, or into another modular adaptor, thereby allowing the simultaneous use of an unlimited number of conventional computer mice. The electronic modular adaptor allows the conventional computer mice to perform cursor control or expanded control such as pan and zoom. The present invention does not force the user to abandon his or her hand actuated mouse, but offers the advantage of allowing a choice.

### CROSS REFERENCE TO RELATED APPLICATIONS

| | | |
|---|---|---|
| 6,204,828 | March 2001 | Amir, et al. |
| 6,107,990 | August 2000 | Fleming, III |
| 6,084,571 | July 2000 | De Gotari |
| 5,999,169 | December 1999 | Lee |
| 5,963,195 | October 1999 | Gregg, et al. |
| 5,917,472 | June 1999 | Perala |
| 5,907,318 | May 1999 | Medina |
| 5,886,685 | March 1999 | Best |
| 5,841,426 | November 1998 | Dodson, et al. |
| 5,838,305 | November 1998 | Bookstein |
| 5,798,752 | August 1998 | Buxton, et al. |
| 5,502,459 | March 1996 | Marshall, et al. |
| 5,334,997 | August 1994 | Scallon |
| 5,245,146 | September 1993 | Florence |
| 4,917,516 | April 1990 | Retter |

### BACKGROUND OF THE INVENTION

The present invention relates in general to a foot actuated adaptor for a computer mouse that is used in conjunction with one or more electronic modular adaptors, which will allow multiple conventional computer mice to be operated with the foot or hand or both simultaneously. In addition to its many benefits, the unique features of the present invention allow persons with physical impairments of the hand to fully operate a conventional computer mouse with a single one of their feet. The present invention also allows a computer user to keep both hands on the home row of the keyboard and still position the mouse by using a single one of their feet.

The mouse is an effective tool for movement and positioning on the computer screen, but poses a problem to fast data-entry. With most conventional computer mice, the computer cursor is moved by moving the computer mouse with the hand while the mouse is positioned on a table or desk. This forces the computer user to physically remove a hand from the keyboard and reach for and position the mouse. This is a hindrance to quick data-entry. Furthermore, with increasingly sophisticated uses for computers constantly being implemented, it is desirable to have more than a single dimensional input. The use of multiple simultaneous mice allows a primary mouse to serve as a user input device for X-Y coordinate axis movement, while the secondary mouse or mice can serve as redundant input or as Scroll, Pan and Zoom, Scale, Stretch, or any other movement or action.

Devices which currently allow control of mouse functions via the computer user's feet are of a specialty nature and typically do not provide for the use of a conventional computer mouse as provided with most computers. Furthermore, these devices are either awkward to use or require use of both feet to achieve both cursor movement and button actuation. Or in the case of adaptors for use with the foot that do allow for conventional computer mice, the adaptor does not allow for articulation of the mouse buttons with the same foot that is moving the mouse. Use of a foot actuated mouse or mouse adaptor simultaneously in conjunction with one or more hand or foot actuated mice or mouse adaptors is not found in the prior art.

Devices which currently allow control of multiple mice do not allow simultaneous use of multiple mouse inputs to control a single cursor. In one instance a switch is used to select one of two conventional computer mice, allowing only a single conventional computer mouse to interface with a computer at any given moment. One such existing device is the Y-Mouse Dual Adaptor by P.I. Engineering, Inc., 101 Innovation Parkway, Williamston, Mich., 48895-1663. Such devices are cumbersome and impede the ability of the user to utilize the computer efficiently. The Y-Mouse Dual Adaptor requires the user to actuate a switch before changing mouse input devices, rather than simply using the desired device when needed.

U.S. Pat. No. 6,204,828 claims an integrated gaze/manual cursor positioning system that uses a gaze tracking apparatus simultaneously with a user input device such as a conventional computer mouse, but does not claim multiple simultaneous conventional computer mouse use, nor does it envision use with a foot actuated computer mouse adaptor, nor does it envision expanded use for one or mice.

U.S. Pat. No. 6,107,990 claims multiple pointing devices, but they are specifically tied to the use of a laptop computer. The use of multiple conventional computer mice is not claimed, nor is use with a foot actuated computer mouse adaptor or with a foot actuated mouse claimed. Furthermore, U.S. Pat. No. 6,107,990 does not claim the use of one or mouse inputs as expanded inputs such as pan and zoom.

U.S. Pat. No. 6,084,571 claims a substantially stationary pressure sensitive system that consists of a platform that can be wobbled by either the hand or foot to position the mouse cursor. Actuation of mouse buttons is achieved via a separate device. A drawback of this kind of platform is that the user is unable to allow his hand or foot to press down in a resting position without moving the cursor, and the user is also unable to move the foot or hand around to different places. This lack of a comfortable resting position combined with the user's restricted hand and foot movements quickly leads to user fatigue. The present invention is an improvement over the prior art because it provides a bottom foam pad 4, hinge base 11, and toe nub 24 that support the weight of the user's foot (or hand) so the user may move the cursor with the foot while bearing down with the full weight of the leg and without actuating the click buttons, thus eliminating user fatigue. Furthermore, the present invention allows the user to move the foot around to any comfortable position rather than maintaining a fixed position, which enhances user comfort. The present invention is also an improvement over the prior art because it allows actuation of a conventional computer mouse with a single foot or a single hand. Furthermore, the present invention claims an adaptor that can be inexpensively upgraded by the user as conventional computer mouse technologies improve. The present invention also allows simultaneous use of multiple conventional computer mice and also allows for one or more conventional computer mice to serve as either redundant cursor control or expanded input such as pan and zoom.

U.S. Pat. No. 5,999,169 claims use of a computer with two cursor input devices such as joysticks or conventional computer mice or both. It is primarily concerned with the control of two separate cursors, however, it does discuss certain expanded functions for one of the input devices such as up/down and left/right scrolling. The present invention differs from U.S. Pat. No. 5,999,169 in that it claims control of only a single cursor. U.S. Pat. No. 5,999,169 does not envision the use of two cursor input devices to control a single cursor, nor does it envision the use of more than two conventional computer mice, nor does it envision a user adjustable electronic modular adaptor 53 to change the performance characteristics of one or more of the cursor input devices, nor does it envision a foot actuated computer mouse adaptor 52.

U.S. Pat. No. 5,963,195 claims a mouse with two adjustment dials, one to adjust cursor speed and one to adjust cursor acceleration of a single mouse. The present invention is an improvement over the prior art because it allows multiple mice to be independently adjusted for cursor control or expanded use, it allows use with multiple conventional computer mice, and it allows use with a foot.

U.S. Pat. No. 5,917,472 claims a cursor control system with multiple pointing devices, however, these pointing devices are claimed to be used by multiple users, namely one owner and one or more customers, where each user controls his own unique cursor with his pointing device. U.S. Pat. No. 5,917,472 does not envision any single user utilizing two or more pointing devices simultaneously to control the same cursor or provide expanded input. The only sharing of mice that is envisioned in U.S. Pat. No. 5,917,472 is the “transfer of control” from one of the customer's mice to temporarily control the owner's cursor. This is a switching action, not simultaneous use of two mice to control a single cursor. The foot actuated computer mouse adaptor 52 of the present invention is unrelated to U.S. Pat. No. 5,917,472. The electronic modular adaptor 53 of the present invention when used in conjunction with two or more conventional computer mice 45 and one or more foot actuated computer mouse adaptors 52 as shown in FIG. 6 and FIG. 7 is an improvement over the prior art. The present invention allows a single user to employ multiple conventional computer mice 45 simultaneously to control a single cursor, and allows the user to adjust the functionality of each conventional computer mouse 45.

U.S. Pat. No. 5,907,318 claims a foot-controlled computer mouse. The drawings and the detailed description of the preferred embodiment indicate that this foot-controlled computer mouse can be used in conjunction with a single hand-held mouse, however, this use does not appear in the claims, and it is not clear how this usage is to be achieved. Furthermore, U.S. Pat. No. 5,907,318 does not envision use with multiple conventional computer mice nor does it envision expanded use for one or more mice. The present invention is an improvement over the prior art because it has a foot actuated computer mouse adaptor 52 that can be used in conjunction with any conventional computer mouse, so it can be upgraded easily as improved conventional computer mouse technologies become available. The present invention is also an improvement over the prior art because it allows for the redundant or expanded use of an arbitrarily large number of conventional computer mice. Furthermore, the present invention allows the user to perform both right and left mouse clicks with a single foot by actuating the right foot pad 16 or the left foot pad 20, whereas U.S. Pat. No. 5,907,318 claims only a single click button and does not provide a resting area for the ball of the foot, thereby requiring the user to lift and lower the weight of the entire leg. The present invention is an improvement over the prior art because it provides a bottom foam pad 4, hinge base 11, and toe nub 24 that support the weight of the user's foot so the user may move the cursor with the foot while bearing down with the full weight of the leg and without actuating the click buttons, thus eliminating user fatigue. The present invention is also an improvement over the prior art because it has very simple construction so it can be manufactured and sold at an affordable cost, and because it has a rugged construction that allows the user to put substantial weight on the foot actuated computer mouse adaptor 52 without breaking it or the conventional computer mouse 45 contained therein.

U.S. Pat. No. 5,886,685 claims a foot operated computer mouse adaptor, but the adaptor claimed does not allow for foot-actuation of the conventional mouse buttons. It also does not claim simultaneous use with a hand-held conventional computer mouse. U.S. Pat. No. 5,886,685 requires the user to either abandon hand actuation of the conventional computer mouse by placing the conventional computer mouse in the foot operated computer mouse adaptor, or to remove the conventional computer mouse from the adaptor and abandon foot actuation in favor of hand actuation. This requirement is an impediment to efficient computer use, and this limitation makes the invention claimed in U.S. Pat. No. 5,886,685 functionally useless to most computer users. The present invention is an improvement over the prior art in that it allows the user to move the cursor and actuate the left and right buttons on a conventional computer mouse 45 with a single foot. The present invention also allows simultaneous use of one or more hand-actuated conventional computer mice in conjunction with one or more foot actuated computer mouse adaptors 52, and the present invention allows one or more conventional computer mice 45 to serve as redundant cursor control or as expanded control (such as pan and zoom).

U.S. Pat. No. 5,841,426 claims a foot operated computer mouse that is stationary. Cursor control is achieved by foot-inclination of a fixed platform. A drawback of this kind of platform is that the user is unable to allow his foot to press down in a resting position without moving the cursor, and the user is also unable to move the foot around to different places. This lack of a comfortable resting position quickly leads to user fatigue. Furthermore, U.S. Pat. No. 5,841,426 envisions click buttons at the edges of the fixed platform, which require the user to reposition the foot in order to actuate click control. The present invention is an improvement over the prior art because it provides a bottom foam pad 4, hinge base 11, and toe nub 24 that support the weight of the user's foot so the user may move the cursor with the foot while bearing down with the full weight of the leg and without actuating the click buttons, thus eliminating user fatigue. Furthermore, the present invention allows the user to move the foot around to any comfortable position rather than maintaining a fixed position, which enhances user comfort. The present invention is also an improvement over the prior art because it envisions simultaneous use with one or more hand or foot operated conventional computer mice 45 thus allowing the user the greatest amount of freedom, flexibility, and upgradability.

U.S. Pat. No. 5,838,305 claims a foot operated control mechanism for computers that is compromised of a table with horizontal and vertical rails that guide a housing containing a conventional computer mouse to achieve foot actuated cursor control. The present invention is an improvement over the prior art because it allows actuation of the mouse buttons on the conventional computer mouse 45, and because it allows the use of multiple hand operated or foot operated conventional computer mice 45, and because it allows expanded use of one or more conventional computer mice 45. Furthermore, the present invention is of a more simplified and low cost construction thus making it more affordable to a wider group of consumers.

U.S. Pat. No. 5,798,752 claims the simultaneous use of two cursor positioning tools, however, in this particular patent the primary cursor positioning tool is used to position a cursor on a computer screen while the secondary cursor positioning tool is used to position a set of tools on the computer screen. The simultaneous use of two separate cursor positioning tools to position a single cursor on the computer screen is not claimed. Furthermore, U.S. Pat. No. 5,798,752 does not claim use with conventional computer mice, nor does it claim use with one or more feet.

U.S. Pat. No. 5,502,459 claims a system that uses a light beam on a screen as a mouse pointing device and also accepts input from a conventional computer mouse, however, it does not claim simultaneous use of the light pointing device with the conventional computer mouse. The present invention is an improvement over the prior art because it allows for simultaneous use of multiple conventional computer mice, and because it allows for one or more conventional computer mice to be used as expanded input such as pan and zoom, and because it allows the user to actuate one or more conventional computer mice with a foot.

U.S. Pat. No. 5,334,997 claims a foot operated computer control that compromises a fixed structure having a track ball and a plurality of switches for controlling a single cursor and mouse buttons with the foot. U.S. Pat. No. 5,334,997 also claims use of two foot actuated track balls to control two separate cursors. A drawback of this kind of fixed structure is that the user is unable to move the foot around to different places. Another drawback is that the user cannot rest the foot on the trackball without moving the cursor. This lack of a comfortable resting position and inability to move the feet and body around quickly leads to user fatigue. The present invention is an improvement over the prior art because it allows the user to comfortably rest or reposition the foot without moving the cursor or actuating the mouse buttons. The present invention is also an improvement over the prior art because it allows use of multiple hand and/or foot actuated mice for the greatest user convenience and comfort. The present invention does not force the user to abandon his or her hand actuated mouse, but offers the advantage of allowing a choice.

U.S. Pat. No. 5,245,146 claims a mouse cover for a hand operated computer control that serves primarily as a decorative and protective cover to keep out dust and dirt. U.S. Pat. No. 5,245,146 does not envision use as a foot actuated computer mouse adaptor, or use with multiple mice. The present invention is an improvement over the prior art because it allows a computer user to use multiple mice with the hands or feet to achieve redundant or expanded use.

U.S. Pat. No. 4,917,516 claims the simultaneous use of two mouse input devices to drive a single cursor, however, no actual method for achieving this simultaneous functionality is described. Furthermore, U.S. Pat. No. 4,917,516 does not claim use with conventional computer mice, nor does it claim use with the foot, nor does it claim use with three or more mice simultaneously. And while it describes utilizing the secondary mouse input as an expanded control, describing “vernier mouse control (rapid and slow), three-dimensional graphics control and the like” it fails to mention exactly how this control might be achieved. It also neglects to mention pan and zoom, scale and stretch, or programmable macro inputs as expanded control options.

The current devices which allow foot control of mouse functions are functionally deficient and awkward and necessitate substantial investment on the part of the computer user in order to implement typical mouse movement via foot movement. Current devices also typically require use of both feet to emulate the functions of a single hand actuated conventional computer mouse. The present invention does not force the user to abandon his or her hand actuated mouse, but offers the advantage of allowing a choice. The present state of the art in foot actuated computer mouse adaptors and foot actuated computer mice in general requires the user to completely abandon their familiar hand actuated conventional computer mouse and replace it with the foot actuated mouse.

As a result, the foot actuated computer mice and foot actuated computer mouse adaptors as well as the modular adaptors for use with multiple mice envisioned in the prior art do not meet the practical needs of the typical computer user.

The present invention solves all these problems. It provides a structurally sound foot actuated computer mouse adaptor 52 which allows for foot control of a conventional computer mouse 45 utilizing a single foot, yet is of such a nature that it would be of minimal cost to the computer user, and would still allow simultaneous hand or foot use of additional conventional computer mice 45 for redundant or expanded data entry when used with the electronic modular adaptor 53. The present invention does not force the user to abandon his or her hand actuated mouse, but offers the advantage of allowing a choice.

Accordingly, it is an object of the present invention to provide a foot actuated computer mouse adaptor 52 which easily allows a conventional computer mouse 45 to be used with a left or right foot of the computer user and thereby speed or expand data entry when used in conjunction with one or more electronic modular adaptors 53 and additional conventional computer mice 45, or provide easier computer operation for those persons with impaired hand function.

Another object of the present invention is to expand the use of hand held musical instruments such as the electric guitar or the keyboard by allowing one or more foot actuated computer mouse adaptors 52 used in conjunction with one or more conventional computer mice 45 to provide action similar to foot pedals. This action will of course be expanded from the action of a typical foot pedal in that the 2-dimensional action of the present invention will allow a greater musical expressiveness than the 1-dimensional action of a typical foot pedal. An alternatively-configured electronic modular adaptor 53 having one or more inputs to accept conventional computer mice 45 used with or without one or more foot actuated computer mouse adaptors 52 could also be configured to accept two standard electric guitar patch cords, and could be used in any existing musical system that accepts standard effects pedals without the need for a computer.

Another object of the present invention is to provide a foot actuated computer mouse adaptor 52, which allows for easy installation, removal and use of a conventional computer mouse 45 without the use of specialty tools or modification of the conventional computer mouse 45.

Another object of the present invention is to provide a foot actuated computer mouse adaptor 52 having simplicity of design, which allows for easy construction and low material costs.

Still another object of the present invention is to provide a foot actuated computer mouse adaptor 52 which is of sufficient strength that it can withstand the weight of a person without breakage and without adversely affecting the conventional computer mouse 45.

A still further object of the present invention is to provide a foot actuated computer mouse adaptor 52 which easily attaches and releases to any size foot whether or not the user's shoe is on.

It is also an object of the present invention to provide an electronic modular adaptor 53 which will read the signals from two separate conventional computer mice and combine them into a single conventional computer mouse 45 signal.

Another object of the present invention is for the functioning of the electronic modular adaptor 53 to be user adjustable via a ratio knob 54 and a function knob 55 to allow one conventional computer mouse 45 to act as a standard mouse input while the other acts as either a redundant mouse input, or as an expanded mouse input such as pan and zoom, scale and stretch, scroll, or any other movement or action.

Another object of the present invention is to allow the output mouse signal from the electronic modular adaptor 53 to serve as an input to another electronic modular adaptor 53, thus allowing an arbitrarily large number of conventional computer mice 45 to be used simultaneously.

### BRIEF SUMMARY OF THE INVENTION

To accomplish the foregoing and other objects of this invention there is provided a foot actuated computer mouse adaptor 52 into which is mounted a conventional computer mouse 45, and an accompanying electronic modular adaptor 53 into which is plugged said conventional computer mouse 45 and either an additional conventional computer mouse 45 or an additional electronic modular adaptor 53. The electronic modular adaptor 53 is then connected to a computer 57.

The foot actuated computer mouse adaptor 52 in its most basic form as shown in FIG. 1 thru FIG. 4B is comprised of a housing constructed from inner foam pads that are called the bottom foam pad 4, top right foam pad 5, and the top left foam pad 6. These inner foam pads are surrounded by wooden rails that are called the right side rail 1, left side rail 2, front rail 3, and hinge base 11. The wooden rails are secured to each other and to the foam pads by brad nails 32, and the entire assembly is secured with two steel bolts and nuts called the rear main bolt 7, rear nut 8, front main bolt 9, and front nut 10. The housing is contoured for the placement of a bare foot or shoe.

Adjustable screws mounted in hinged pads actuate the mouse buttons on the conventional computer mouse 45 in response to movements of the user's foot. These assemblies on the right side are compromised of a right foot pad 16, a right foot pad screw stabilizer 17 which helps secure the right foot pad adjustment screw 18, and a right foot pad screw cushion 19 which prevents the right foot pad adjustment screw 18 from scratching the conventional computer mouse 45. Additionally these assemblies on the left side are compromised of a left foot pad 20, left foot pad screw stabilizer 21, left foot pad adjustment screw 22, and left foot pad screw cushion 23. The right foot pad adjustment screw 18 and left foot pad adjustment screw 22 are shown in FIG. 1 thru FIG. 4B as penetrating the right foot pad 16 and left foot pad 20. Alternately, the right foot pad adjustment screw 18 and left foot pad adjustment screw 22 are recessed below the right foot pad 16 and left foot pad 20 and do not penetrate the top surface of the right foot pad 16 and left foot pad 20. Instead, the right foot pad screw stabilizer 17 and left foot pad screw stabilizer 21 will each be compromised of a fixed cylindrical projection threaded on its inner surface that is affixed below the right foot pad 16 and left foot pad 20, and the right foot pad adjustment screw 18 and left foot pad adjustment screw 22 will thread up into the inside of the fixed cylinders, thus eliminating interference with the user's foot.

The left hinge 15 and right hinge 14 are compromised of metal such as brass and are affixed to the hinge base 11 and the left foot pad 20 and right foot pad 16 with hinge screws 31. A right toe nub stabilizer 12 and a left toe nub stabilizer 13 are affixed to the hinge base 11 with brad nails 32, and the toe nub 24 fits in between the right toe nub stabilizer 12, and the left toe nub stabilizer 13 into a slot called the toe nub gap 38. Alternatively, the hinge base 11, the right toe nub stabilizer 12 and the left toe nub stabilizer 13 could be a single piece of material. The right hinge 14 and left hinge 15 can also be made of other materials such as nylon, polycarbonate, PVC, fiberglass, or any suitable polymer or composite material. Alternatively, the right hinge 14 and left hinge 15 can be of a different configuration, such as rectangular PVC sheets that are affixed via staples or glue to the hinge base 11, right foot pad 16, and left foot pad 20. Or the right hinge 14 and left hinge 15 could be compromised of metal or plastic wires that extrude from the hinge base 11 directly into the left foot pad 20 and right foot pad 16. Or the hinge base 11, right foot pad 16, and left foot pad 20 could all be assembled from a single piece of polymer or composite material with a crease or structurally weakened zone between each foot pad and the hinge base 11 to act as the right hinge 14 and left hinge 15 and allow for lifting and lowering of the right foot pad 16 and left foot pad 20.

In a preferred embodiment, the housing has a keyhole shaped cavity 39 in its most bottom portion that will accommodate the dimensions of a conventional computer mouse 45. The front rail 3 also has a mouse cord hole 40 cut out of it to accommodate the cord of the conventional computer mouse 45, or to allow for wireless communication. Alternatively, the front rail 3 could be transparent to the electromagnetic or sonic radiation used by the conventional computer mouse 45 to achieve wireless communication.

To assemble the preferred embodiment, the computer user places a conventional computer mouse 45 on a substantially flat surface, places the foot actuated computer mouse adaptor 52 over the conventional computer mouse 45, and then places the top foil tape piece 27 over the top of the conventional computer mouse 45 and secures it firmly to the top right foam pad 5 and top left foam pad 6 of the foot actuated computer mouse adaptor 52 by pressing the top foil tape piece 27 down to achieve the result shown in FIG. 1. The user then turns the housing of the foot actuated computer mouse adaptor 52 over and places the first bottom foil tape piece 28, the second bottom foil tape piece 29 and the third bottom foil tape piece 30 onto the bottom of the conventional computer mouse 45 and the bottom foam pad 4 to produce the result shown in FIG. 2. Because the foil tape pieces are relatively rigid, they allow conventional computer mice 45 of various sizes to be held firmly in place, and the tape will retain its structural integrity over months or years of continuous use. And because the foil tape can be easily cut with a fingernail or pen, it is easy to remove the conventional computer mouse 45 and tape in a replacement conventional computer mouse 45. This allows for easy upgrades as conventional computer mouse 45 technologies advance from rollerball mechanisms to optical sensors and beyond.

Alternatively, the foot actuated computer mouse adaptor 52 and the conventional computer mouse 45 can be manufactured together and sold as a single unit. The conventional computer mouse can either be secured with tape at the factory as described above or could be fused with the bottom foam pad 4. In this alternative embodiment, the present invention offers advantages over the prior art in that the user does not have to assemble anything. Furthermore, this alternative embodiment excels over existing foot actuated mice in that the mouse can be fully articulated with a single foot and the assembly is strong enough not to break when a user applies weight to it.

In a preferred embodiment, the foot is held to the top of the housing with two straps. The straps attach via notches in the right side rail 1 and the left side rail 2. These notches are called rear vertical side rail notches 33, rear diagonal side rail notches 34, middle vertical side rail notches 35, front diagonal side rail notches 36 and front vertical side rail notches 37. These notches secure the heel strap 26 and foot strap 25 by the force of friction, while allowing continuous adjustability of the straps, which is an advantage over the pegs and holes envisioned in the prior art (U.S. Pat. No. 5,886,685). The foot strap 25 and heel strap 26 are woven of nylon or some other fiber and may or may not have elastic properties, and may be extended behind and optionally over the foot, with or without a shoe, and secured thru the notches in the right side rail 1 and the left side rail 2. The heel strap 26 is necessary to secure the foot to the foot actuated computer mouse adaptor 52, but the foot strap 25 is optional. Using the foot strap 25 will allow the user's foot to remain more securely attached to the foot actuated computer mouse adaptor 52, and not using the foot strap 25 will allow the user to more quickly remove his or her foot, allowing for easier use which is an advantage over the prior art (U.S. Pat. No. 5,886,685). At this point of assembly, the foot actuated computer mouse adaptor 52 along with the conventional computer mouse 45 is held securely to the foot and may be used on any substantially flat surface.

An alternate to the preferred embodiment would have a top surface that is composed of gel instead of styrofoam, or the top surface could be coated with tiny rubber knobs to massage the user's foot when the user is not wearing a shoe. The inside of the keyhole shaped cavity 39 could also extend inward to touch and partially or fully hold the conventional computer mouse 45.

Another alternate to the preferred embodiment is the use of the foot actuated computer mouse adaptor 52 for hand-actuation. The nature of the present invention is to allow articulation of the mouse buttons with a large clumsy appendage such as the foot. The present invention is also suitable for use by a user with limited mobility in the hand. The design of the present invention allows an individual to perform fully articulated mouse motions with a clenched fist, or with the hand in a brace or cast. The present invention will also allow full articulation of the buttons and cursor control of a conventional computer mouse 45 with a partially amputated or deformed limb. To actuate the conventional computer mouse 45 buttons the user rolls his fist, foot or other appendage left or right. Usage of the present invention will also completely eliminate the causes of repetitive stress injuries such as carpal tunnel syndrome in users with normal hand function.

In an alternative embodiment, the back of the foot actuated computer mouse adaptor 52 could have a bevel cut along its bottom. This would allow a user to lift the conventional computer mouse 45 contained inside the foot actuated computer mouse adaptor 52 by simply rocking the foot back. This would allow the user to easily reposition the foot actuated computer mouse adaptor 52 without moving the cursor.

In the event that the user does not perfectly align the conventional computer mouse 45 within the keyhole shaped cavity 39 so that the conventional computer mouse 45 is flat to the floor when the foot actuated computer mouse adaptor 52 is placed on the floor; the toe nub 24 will automatically correct this problem. When the user applies pressure with his foot to the foot actuated computer mouse adaptor 52, the freely floating toe nub 24 will be forced down onto the conventional computer mouse 45 and will force it flat onto the floor, thereby eliminating any alignment problem. Because the physical structure of the toe nub 24 is mostly supported by structural elements of the foot actuated computer mouse adaptor 52, such as the hinge base 11 and the bottom foam pad 4, only a small fraction of the user's weight is transferred to the conventional computer mouse 45, thereby preventing the user's weight from bearing down too hard on the conventional computer mouse 45. This allows the user to exert a large force on the foot actuated computer mouse adaptor 52 without damaging the conventional computer mouse 45, which is an advantage over the prior art.

The present invention is more comfortable to use than any other foot actuated device because the bottom foam pad 4, hinge base 11, and the toe nub 24 support the full weight of the user's foot without allowing accidental actuation of the buttons on the conventional computer mouse 45. The user actuates the mouse buttons by rocking the foot slightly to the left or right, but the user does not have to expend any energy holding up the weight of his or her leg to prevent button actuation. This provides mouse button actuation ability and eliminates the user fatigue that has previously hindered the development of the foot actuated computer mouse and foot actuated computer mouse adaptor markets.

The housing is manufacturable from different materials and in different sizes and colors. Usable materials include plastic, wood, metal, fiberglass and composites. In one preferred embodiment, the inner housing is comprised of a styrofoam-type material and the outer housing is composed of wood or polycarbonate. The straps are also manufacturable from different materials and in different sizes and colors. Usable materials include plastic, leather, rubber, metal, cloth or any inelastic or elastic material. In one preferred embodiment, the straps are comprised of woven nylon.

The electronic modular adaptor 53 in its most basic form is comprised of an electronics housing 41 made of wood, metal, or plastic, and is shown schematically in FIG. 5. A primary mouse input port 42 accepts a connector from a conventional computer mouse 45, and a secondary mouse input port 43 also accepts connector from another conventional computer mouse 45. The signals from the primary mouse input port 42 and the secondary mouse input port 43 are processed by the various logic circuits which are as follows: horizontal and expanded movement logic 46, vertical and expanded movement logic 47, scroll and expanded movement logic 48, left mouse button and expanded button logic 49, center mouse button and expanded button logic 50, and right mouse button and expanded button logic 51. After processing by these various logic circuits, the output signal is transmitted to the combined mouse output port 44. The input and output ports are each shown schematically as 6-wire ports in FIG. 5, and the internal logic circuitry is shown as being configured for these 6-wire ports and further compromised of one logic communications bus 56. However, in actuality the input and output ports will most likely be standard PS/2, USB, or wireless ports and the internal logic circuits will be configured accordingly.

FIG. 6 shows use of the electronic modular adaptor 53 with a computer 57, a conventional computer mouse 45 and another conventional computer mouse 45 that is held in a foot actuated computer mouse adaptor 52. FIG. 7 shows use of the electronic modular adaptor 53 with a computer 57, additional electronic modular adaptors 53, more than two conventional computer mice 45, and one or more foot actuated computer mouse adaptors 52.

The user can plug the conventional computer mouse 45 that is held inside the foot actuated computer mouse adaptor 52 into the electronic modular adaptor 53 along with another conventional computer mouse 45 that is hand actuated as shown in FIG. 6. The input from the two conventional computer mice 45 is combined by the electronic modular adaptor 53 and serves as a single conventional computer mouse 45 input to the computer 57.

Alternatively, the user can achieve redundant use by using one conventional computer mouse 45 in conjunction with a second conventional computer mouse 45, both being identical and having USB connection ports, by connecting them to the computer as follows: First the user connects a USB-to-PS/2 adaptor to the USB plug on one conventional computer mouse 45 and plugs it into the PS/2 port of the computer. Then the user restarts the computer and installs the mouse software. Then the user plugs the second conventional computer mouse 45 into the USB port on the back of the computer 57, goes thru the software install one more time and finally restarts the computer. In this configuration the computer will recognize the inputs from both conventional computer mice 45, and will allow them to be used simultaneously.

The various logic circuits 46-51 are able to communicate with one another via a plurality of internal electronic or opto-electronic circuits shown as a logic communications bus 56. The ratio knob 54 and function knob 55 are also connected to these circuits as shown schematically in FIG. 5.

The position of the ratio knob 54 and the function knob 55 determine the actual functioning of the various logic circuits 46-51, whose output is fed to the combined mouse output port 44. Alternatively, the ratio knob 54 and the function knob 55 could be compromised of multiple knobs. In a particular alternative embodiment, two ratio knobs will be used, one to control relative speed between cursors, and one to control relative acceleration between cursors. This is an improvement over the prior art (U.S. Pat. No. 5,963,195) where speed and accelerator dials are used to control the speed and acceleration of a single mouse. The present invention claims use with multiple conventional computer mice 45 and also claims additional functionality for one or more conventional computer mice 45 via utilization of the function knob 55.

Redundant or expanded use can be user selectable with the function knob 55. Alternatively, redundant or expanded use can be programmed into the various logic circuits 46-51 using the widely available erasable programmable read only memory chip technology, or EPROM. Alternatively, redundant or expanded use can be hard wired into the various logic circuits 46-51. Redundant use allows both conventional computer mice 45 to perform identical functions, while expanded use allows one or both mice to take on pan and zoom, scale and stretch, or any other expanded function desired by the user.

The horizontal and expanded movement logic 46 reads horizontal or expanded movement input from the primary mouse input port 42 and the secondary mouse input port 43, then processes it along with any relevant input from the other various logic circuits 46-51, and sends the resultant signal as an output to the combined mouse output port 44. In redundant mode, the horizontal and expanded movement logic 46 simply sums the two horizontal signals to produce the combined output signal. In expanded mode, the horizontal signal from the primary mouse input port 42 or the horizontal signal from the secondary mouse input port 43 or both will be used to represent some other command such as pan and zoom, object manipulation, multiple cursor control, or programmable macro inputs. In this case, the horizontal and expanded movement logic 46 interprets the cursor control signal of the expanded use conventional computer mouse 45 as a particular expanded command such as pan or zoom, and transmits the appropriate signal to the combined mouse output port 44.

The vertical and expanded movement logic 47, scroll and expanded movement logic 48, left mouse button and expanded button logic 49, center mouse button and expanded button logic 50, and right mouse button and expanded button logic 51 all function with their various inputs in the same manner just described for the horizontal and expanded movement logic 46 in the preceding paragraph.

By selecting various settings on the function knob 55, the user can alter the function of the primary mouse input port 42, or the secondary mouse input port 43, or both. One setting will allow a conventional computer mouse 45 to function as a cursor pointing device while a second conventional computer mouse 45 will function as a redundant cursor pointing device with a speed adjustable by the ratio knob 54, another will allow one or both conventional computer mice 45 to achieve 2-dimensional scrolling and zoom functions, another will scale and stretch objects and perform various object manipulation techniques based on cursor motion and mouse button activation.

By selecting various settings on the ratio knob 54, the user can speed up or slow down cursor movements received from the secondary mouse input port 43 relative to the cursor movements received from the primary mouse input port 42. This allows the user to independently adjust the cursor speed on each conventional computer mouse 45. Alternatively, acceleration or independent speed control adjustment could also be achieved by another knob in addition to the ratio knob. Alternatively, any number of switches, dial and knobs could be used to achieve any number of effects on the signals presented to the electronic modular adaptor 53. The preferred embodiment of the present invention has two knobs, a ratio knob 54 and a function knob 55 for the sake of simplicity. If the market should demand additional controls at a later time, it is a trivial matter to add any number of such controls to the electronic modular adaptor 53 without altering its basic functionality.

The basic function of the electronic modular adaptor is to combine the signals coming from a conventional computer mouse 45 with those signals from another conventional computer mouse 45 into one signal representing the motion of a single cursor on the screen of a computer 57, along with any expanded function input. A system in accordance with the present invention provides the user with many advantageous features, such as the ability to move a cursor, to pan and zoom, to scale and stretch an object, to rotate an object left/right, or to move forward/backward thru a sequence of frames displayed by an application window, or to utilize programmable macro inputs including the use of multiple cursors.

The present invention provides a structurally sound foot actuated computer mouse adaptor 52 which allows for foot control of a conventional computer mouse 45 utilizing a single foot, yet is of such a nature that it would be of minimal cost to the computer user, and would still allow simultaneous hand or foot use of additional conventional computer mice 45 for redundant or expanded data entry when used with the electronic modular adaptor 53. The present invention does not force the user to abandon his or her hand actuated mouse, but offers the advantage of allowing a choice.

### BRIEF DESCRIPTION OF THE DRAWINGS

Numerous other objects, features and advantages of the invention should now become apparent upon a reading of the following detailed description taken in conjunction with the accompanying drawings, in which:

FIG. 1 is a top isometric partially exploded view of a preferred embodiment of a foot actuated computer mouse adaptor 52 with a conventional computer mouse 45 installed within its keyhole shaped cavity 39;

FIG. 2 is a bottom isometric view of a preferred embodiment of a foot actuated computer mouse adaptor 52 with a conventional computer mouse 45 installed within its keyhole shaped cavity 39;

FIG. 3A is the upper portion of a top isometric exploded view of a preferred embodiment of a foot actuated computer mouse adaptor 52;

FIG. 3B is the lower portion of a top isometric exploded view of a preferred embodiment of a foot actuated computer mouse adaptor 52;

FIG. 4A is the upper portion of a bottom isometric exploded view of a preferred embodiment of a foot actuated computer mouse adaptor 52;

FIG. 4B is the lower portion of a bottom isometric exploded view of a preferred embodiment of a foot actuated computer mouse adaptor 52;

FIG. 5 is a schematic diagram of the internal logic of a preferred embodiment of an electronic modular adaptor 53;

FIG. 6 is a schematic diagram of a preferred embodiment of an electronic modular adaptor 53 and a foot actuated computer mouse adaptor 52 when used to achieve simultaneous operation of two conventional computer mice 45;

FIG. 7 is a schematic diagram of a preferred embodiment of a plurality of electronic modular adaptors 53 and one or more foot actuated computer mouse adaptors 52 when used to achieve simultaneous operation of more than two conventional computer mice 45.

### DETAILED DESCRIPTION

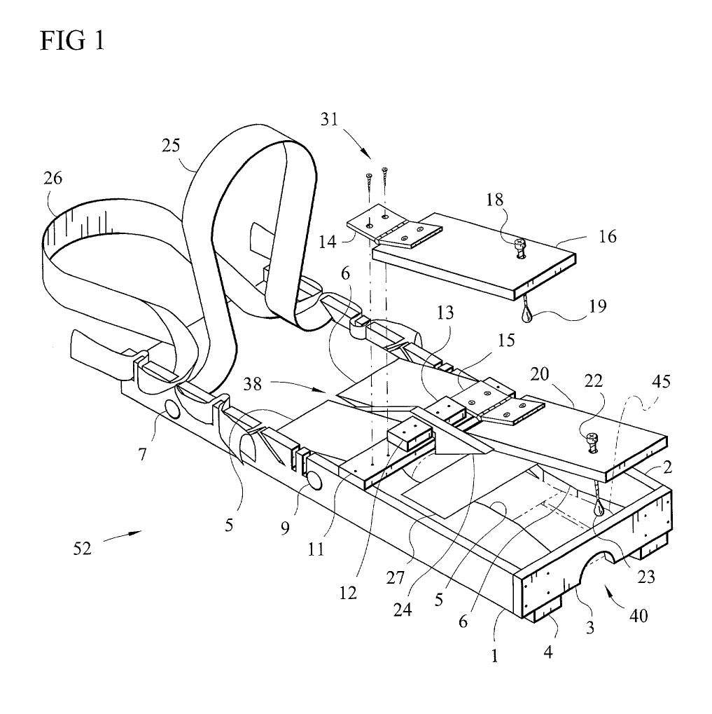

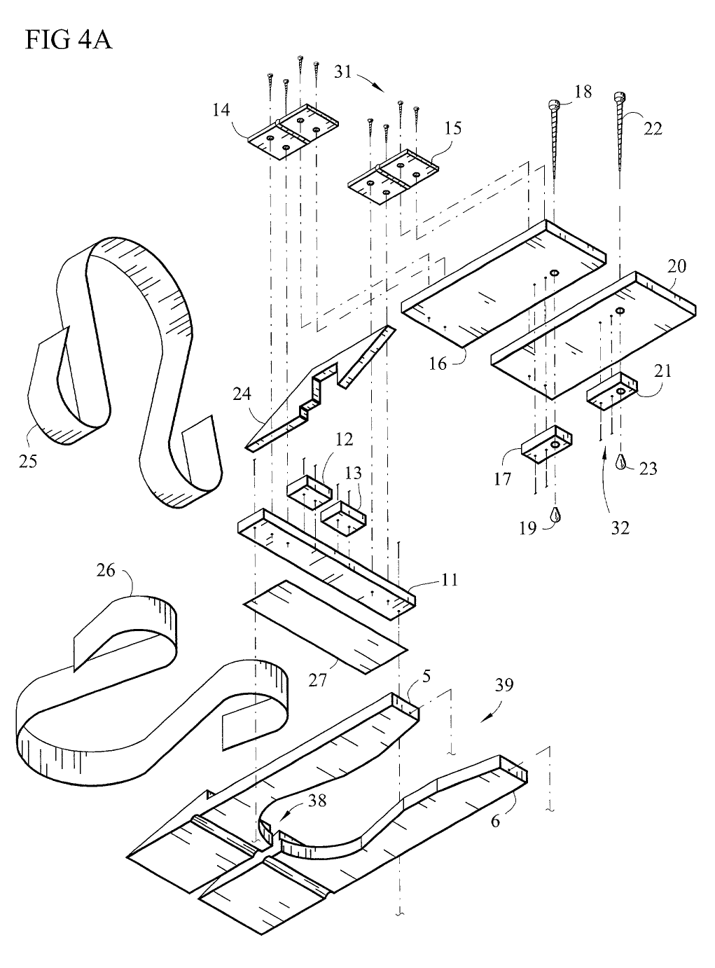

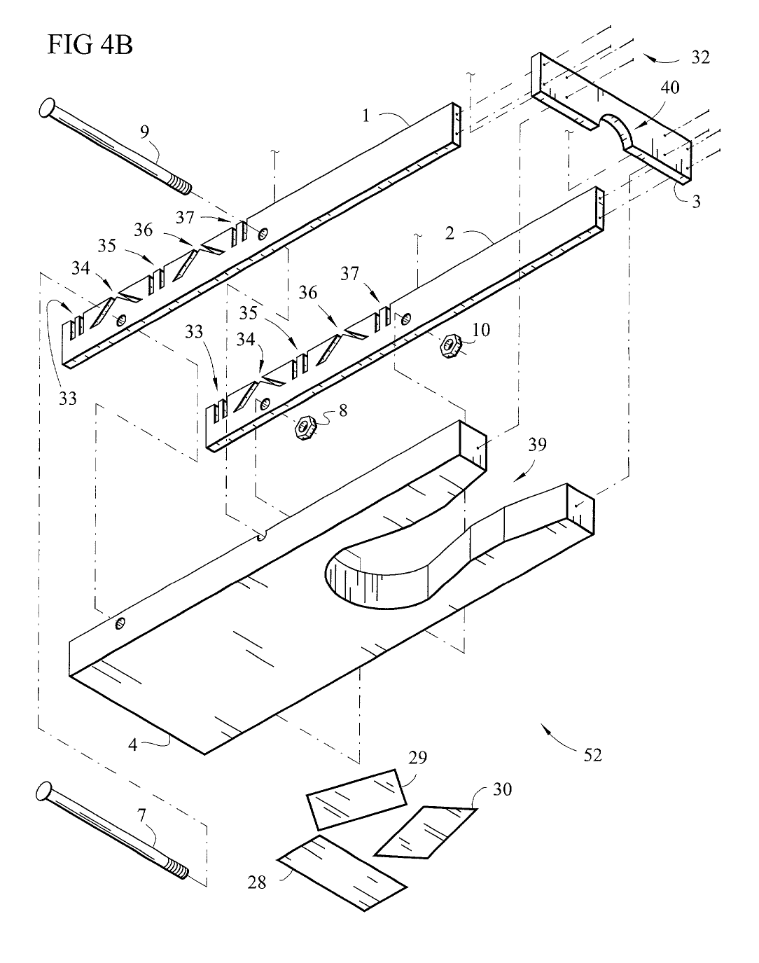

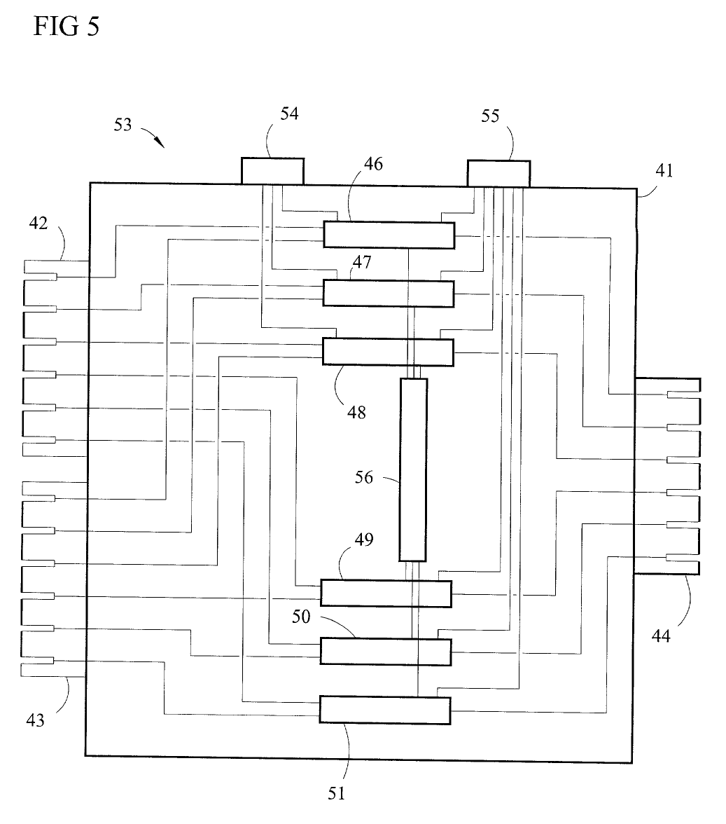

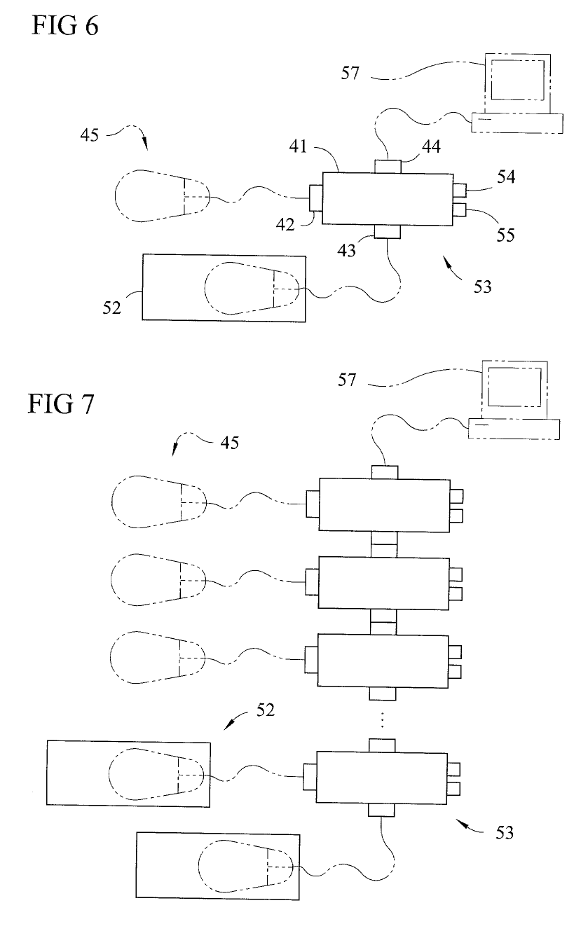

Referring now to the drawings there is shown in FIG. 1 thru FIG. 4B a preferred embodiment of a foot actuated computer mouse adaptor 52, and there is shown in FIG. 5 a schematic diagram of a preferred embodiment of an electronic modular adaptor 53, and there is shown in FIG. 6 and FIG. 7 preferred embodiments of a foot actuated computer mouse adaptor 52 used in conjunction with one or more electronic modular adaptors 53 and one or more conventional computer mice 45. The foot actuated computer mouse adaptor 52 and electronic modular adaptor 53 are described in connection with one or more conventional computer mice 45, a computer user's foot or feet, a computer user's hand or hands, and a computer 57. All parts that are herein described as being composed of wood could also be composed of other strong light materials such as polycarbonate or aluminum.

Referring to FIG. 1 thru FIG. 4B: In the preferred embodiment, the foot actuated computer mouse adaptor 52 is constructed from three inner polymer foam pads: the bottom foam pad 4, the top right foam pad 5 and the top left foam pad 6; which are surrounded by four wooden rails, the right side rail 1, the left side rail 2, the front rail 3, and the hinge base 11. These structures are fastened together with brad nails 32, the rear main bolt 7, the rear nut 8, the front main bolt 9, and the front nut 10. Cut into the three inner polymer foam pads is a keyhole shaped cavity 39 into which a conventional computer mouse 45 is inserted.

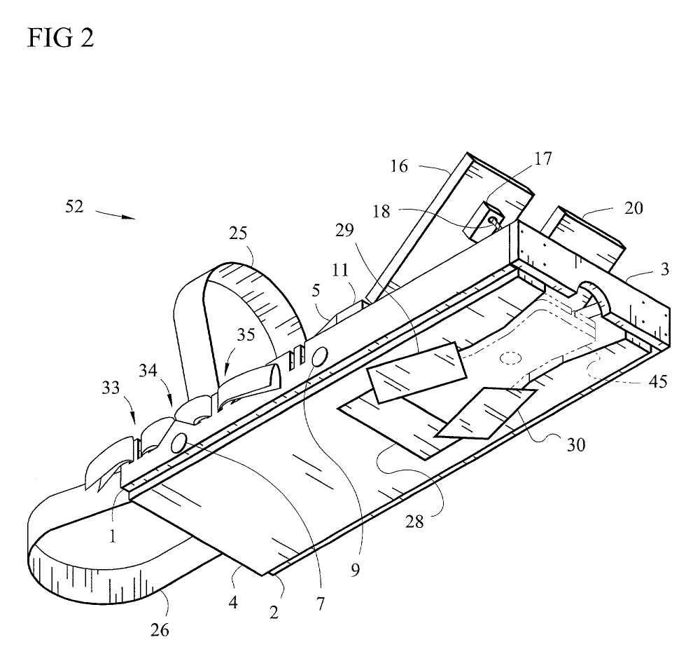

After the user inserts the conventional computer mouse 45 into the keyhole shaped cavity 39, the user places the top foil tape piece 27 over the top of the conventional computer mouse 45 so as to affix the conventional computer mouse 45 to the top surfaces of the top right foam pad 5 and the top left foam pad 6, the result of which can be seen in FIG. 1. The user then turns over the foot actuated computer mouse adaptor 52 and affixes the first bottom foil tape piece 28, the second bottom foil tape piece 29, and the third bottom foil tape piece 30, the result of which can be seen in FIG. 2.

A mouse cord hole 40 is present in the front rail 3 to allow the cord of a conventional computer mouse 45 to protrude, or to allow the sound or light waves to propagate from a conventional computer mouse 45 that is cordless.

Fastened with brad nails 32 to the top of the hinge base 11 are the right toe nub stabilizer 12 and the left toe nub stabilizer 13, which are spaced the same width apart as the width of the toe nub gap 38 that lies between the top right foam pad 5 and the top left foam pad 6. The toe nub 24 is a free floating part that is placed in the toe nub gap 38, over the hinge base 11, and in between the right toe nub stabilizer 12 and left toe nub stabilizer 13. The purpose of this toe nub 24 is to exert force downward on the conventional computer mouse 45 when the user's foot is placed down on the foot actuated computer mouse adaptor 52. In this manner the conventional computer mouse 45 will lie flat against any substantially flat surface when the user applies weight with his foot. Since most of the user's weight is distributed on the rear portion of the foot actuated computer mouse adaptor 52, and since only a small fraction of the force on the toe nub is actually transferred to the conventional computer mouse 45, the mouse is held down firmly but does not bend or break.

The present invention is more comfortable to use than any other foot actuated device because the bottom foam pad 4, hinge base 11, and the toe nub 24 support the full weight of the user's foot without allowing accidental actuation of the buttons on the conventional computer mouse 45. The user actuates the mouse buttons by rocking the foot slightly to the left or right, but the user does not have to expend any energy holding up the weight of his or her leg to prevent button actuation. This provides mouse button actuation ability and eliminates the user fatigue that has previously hindered the development of the foot actuated computer mouse and foot actuated computer mouse adaptor markets.

The right hinge 14 is fastened to the hinge base 11 and the right foot pad 16 with hinge screws 31. The left hinge 15 is fastened to the hinge base 11 and the left foot pad 20 with hinge screws 31.

The right foot pad 16 has a wooden right foot pad screw stabilizer 17 that is affixed to its underside with brad nails 32 or embedded within. Similarly, the left foot pad 20 has a left foot pad screw stabilizer 21 that is affixed to its underside with brad nails 32 or embedded within. The purpose of these screw stabilizers 17,21 is to keep the right foot pad adjustment screw 18 and the left foot pad adjustment screw 22 firmly aligned within the right foot pad 16 and left foot pad 20. The right foot pad adjustment screw 18 and left foot pad adjustment screw 22 are shown in FIG. 1 thru FIG. 4B as penetrating the right foot pad 16 and left foot pad 20. Alternately, the right foot pad adjustment screw 18 and left foot pad adjustment screw 22 are recessed below the right foot pad 16 and left foot pad 20 and do not penetrate the top surface of the right foot pad 16 and left foot pad 20. Instead, the right foot pad screw stabilizer 17 and left foot pad screw stabilizer 21 will each be compromised of a fixed cylindrical projection threaded on its inner surface that is affixed below the right foot pad 16 and left foot pad 20, and the right foot pad adjustment screw 18 and left foot pad adjustment screw 22 will thread up into the inside of the fixed cylinders, thus eliminating interference with the user's foot.

At the end of the right foot pad adjustment screw 18 is the right foot pad screw cushion 19. And at the end of the left foot pad adjustment screw 22 is the left foot pad screw cushion 23. The purpose of these screw cushions is to protect the buttons on the conventional computer mouse 45 from scratches from the right foot pad adjustment screw 18 and left foot pad adjustment screw 22. Alternatively, the right foot pad adjustment screw 18 and left foot pad adjustment screw 22 could be made of a hard non-scratch material such as nylon and may not require cushions.

The purpose of the right foot pad adjustment screw 18 is to allow the user to adjust the height of the right foot pad 16, and the purpose of the left foot pad adjustment screw 22 is to allow the user to adjust the height of the left foot pad 20.

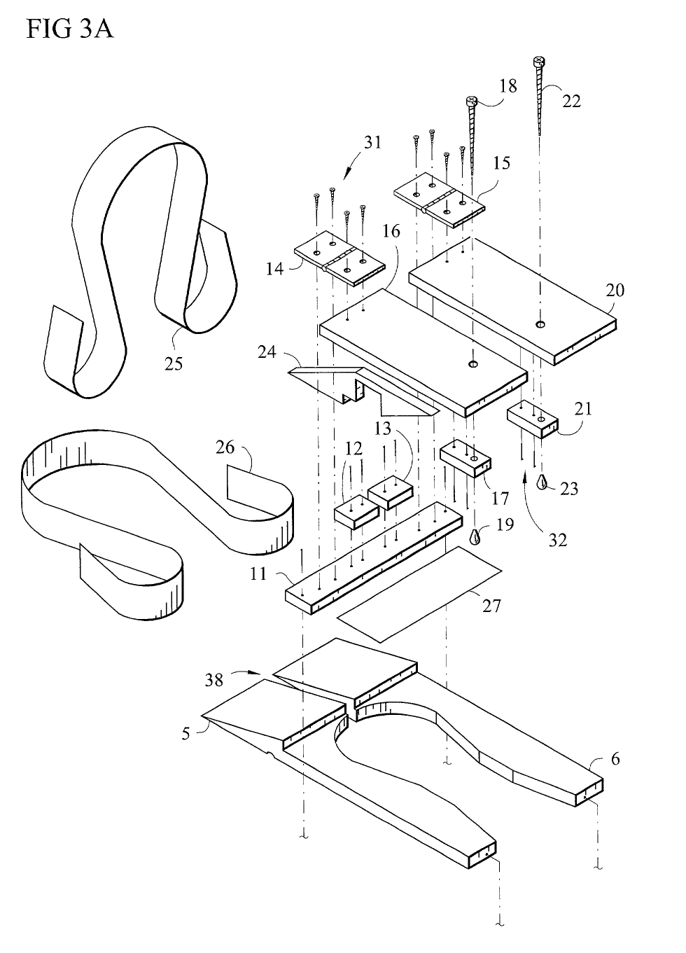

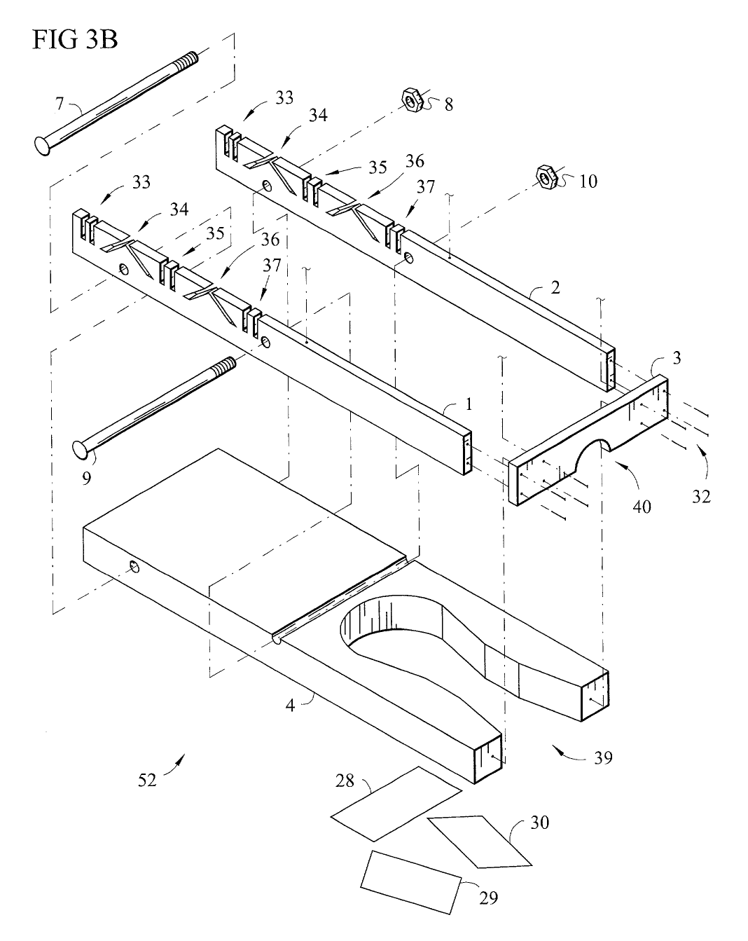

The foot strap 25 and heel strap 26 are secured to the foot actuated computer mouse adaptor 52 by means of a plurality of notches called the rear vertical side rail notches 33, the rear diagonal side rail notches 34, the middle vertical side rail notches 35, the front diagonal side rail notches 36, and the front vertical side rail notches 37. These notches are cut into both the right side rail 1 and the left side rail 2 in an identical fashion which can most clearly be seen in FIG. 3B.

Referring to FIG. 1 and FIG. 2, to affix the heel strap 26, the user selects either the rear diagonal side rail notches 34 or the front diagonal side rail notches 36 depending on foot size, and then starting on either the right or the left side, folds the heel strap 26 in half lengthwise and inserts the folded heel strap 26 into the diagonal notch that slants rearward. Weaving the folded strap out, the user then weaves it in and out of the vertical notches immediately behind the diagonal notch and pulls the heel strap 26 tight. After positioning the foot and pulling the heel strap 26 firmly up behind the heel, the user then repeats the same steps by weaving the heel strap 26 thru the notches on the other side. The user affixes the foot strap 25 in the same manner but chooses the forward slanting diagonal notch as a starting point and weaves forward, the result of which is clearly shown in FIG. 1.

The electronic modular adaptor 53 in its most basic form is comprised of an electronics housing 41 made of wood, metal, or plastic, and is shown schematically in FIG. 5. A primary mouse input port 42 accepts a connector from a conventional computer mouse 45, and a secondary mouse input port 43 also accepts a connector from another conventional computer mouse 45. The signals from the primary mouse input port 42 and the secondary mouse input port 43 are processed by the various logic circuits which are as follows: horizontal and expanded movement logic 46, vertical and expanded movement logic 47, scroll and expanded movement logic 48, left mouse button and expanded button logic 49, center mouse button and expanded button logic 50, and right mouse button and expanded button logic 51. The input and output ports 42-44 are each shown schematically as 6-wire ports in FIG. 5, and the various logic circuits are shown as being compromised of six logic circuits 46-51 and one logic communications bus 56. However, in actuality the input and output ports 42-44 will most likely be standard PS/2, USB, or wireless ports and the logic circuits will be configured accordingly.

FIG. 6 shows use of the electronic modular adaptor 53 with a computer 57, a conventional computer mouse 45 and another conventional computer mouse 45 that is held in a foot actuated computer mouse adaptor 52. FIG. 7 shows use of the electronic modular adaptor 53 with a computer 57, additional electronic modular adaptors 53, more than two conventional computer mice 45, and one or more foot actuated computer mouse adaptors 52.

The user can plug the conventional computer mouse 45 that is held inside the foot actuated computer mouse adaptor 52 into the electronic modular adaptor 53 along with another conventional computer mouse 45 that is hand actuated as shown in FIG. 6. The input from the two conventional computer mice is combined by the electronic modular adaptor 53 and serves as a single conventional computer mouse 45 input to the computer 57 via the combined mouse output port 44.

The various logic circuits 46-51 are able to communicate with one another via a plurality of internal electronic or opto-electronic circuits shown as a logic communications bus 56. The ratio knob 54 and function knob 55 are also connected to the various logic circuits 46-51.

The position of the ratio knob 54 and the function knob 55 determine the actual functioning of the various logic circuits 46-51, whose output is fed to the combined mouse output port 44.

The horizontal and expanded movement logic 46 reads horizontal or expanded movement input from the primary mouse input port 42 and the secondary mouse input port 43, then processes it along with any relevant input from the other various logic circuits 46-51, and sends the resultant signal as an output to the combined mouse output port 44. In redundant mode, the horizontal and expanded movement logic 46 simply sums the two horizontal signals to produce the combined output signal. In expanded mode, the horizontal signal from the primary mouse input port 42 or the horizontal signal from the secondary mouse input port 43 or both will be used to represent some other expanded function such as pan and zoom, object manipulation, multiple cursor control, or programmable macro inputs. In this case, the horizontal and expanded movement logic 46 interprets the cursor control signal of the expanded use conventional computer mouse 45 as a particular expanded function such as pan or zoom, and transmits the appropriate signal to the combined mouse output port 44.

The vertical and expanded movement logic 47 reads vertical or expanded movement input from the primary mouse input port 42 and the secondary mouse input port 43, then processes it along with any relevant input from the other various logic circuits 46-51, and sends the resultant signal as an output to the combined mouse output port 44. In redundant mode, the vertical and expanded movement logic 47 simply sums the two vertical signals to produce the combined output signal. In expanded mode, the vertical signal from the primary mouse input port 42 or the vertical signal from the secondary mouse input port 43 or both will be used to represent some other expanded function such as pan and zoom, object manipulation, multiple cursor control, or programmable macro inputs. In this case, the vertical and expanded movement logic 47 interprets the cursor control signal of the expanded use conventional computer mouse 45 as a particular expanded function such as pan or zoom, and transmits the appropriate signal to the combined mouse output port 44.

The scroll and expanded movement logic 48 reads scroll or expanded scroll input from the primary mouse input port 42 and the secondary mouse input port 43, then processes it along with any relevant input from the other various logic circuits 46-51, and sends the resultant signal as an output to the combined mouse output port 44. In redundant mode, the scroll and expanded movement logic 48 simply sums the two scroll signals to produce the combined output signal. In expanded mode, the scroll signal from the primary mouse input port 42 or the scroll signal from the secondary mouse input port 43 or both will be used to represent some other expanded function such as pan and zoom, object manipulation, multiple cursor control, or programmable macro inputs. In this case, the scroll and expanded movement logic 48 interprets the scroll signal of the expanded use conventional computer mouse 45 as a particular expanded function such as pan or zoom, and transmits the appropriate signal to the combined mouse output port 44.

The left mouse button and expanded button logic 49 reads left mouse button or expanded left mouse button input from the primary mouse input port 42 and the secondary mouse input port 43, then processes it along with any relevant input from the other various logic circuits 46-51, and sends the resultant signal as an output to the combined mouse output port 44. In redundant mode, the left mouse button and expanded button logic 49 simply sums the two left mouse button signals to produce the combined output signal. In expanded mode, the left mouse button signal from the primary mouse input port 42 or the left mouse button signal from the secondary mouse input port 43 or both will be used to represent some other expanded function. Typically, expanded left mouse button input will cause some kind of alteration to the performance of the expanded cursor and scroll inputs from the expanded conventional computer mouse 45. For instance, the expanded use conventional computer mouse 45 might pan up/down or left/right when its left mouse button is not depressed and might zoom in/out when its left mouse button is depressed. Or pressing the left mouse button could toggle the user thru a series of modes, such as single cursor/multiple cursor. In this case, the left mouse button and expanded button logic 49 interprets the left mouse button input signal of the expanded use conventional computer mouse 45 as a particular expanded function modifier, and transmits the appropriate signal to the combined mouse output port 44.

The center mouse button and expanded button logic 50 reads center mouse button or expanded center mouse button input from the primary mouse input port 42 and the secondary mouse input port 43, then processes it along with any relevant input from the other various logic circuits 46-51, and sends the resultant signal as an output to the combined mouse output port 44. In redundant mode, center mouse button and expanded button logic 50 simply sums the two center mouse button signals to produce the combined output signal. In expanded mode, the center mouse button signal from the primary mouse input port 42 or the center mouse button signal from the secondary mouse input port 43 or both will be used to represent some other expanded function. Typically, expanded center mouse button input will cause some kind of alteration to the performance of the expanded cursor and scroll inputs from the expanded conventional computer mouse 45. For instance, the expanded use conventional computer mouse 45 might pan up/down or left/right when its center mouse button is not depressed and might zoom in/out when its center mouse button is depressed. Or pressing the center mouse button could toggle the user thru a series of modes, such as single cursor/multiple cursor. In this case, the center mouse button and expanded button logic 50 interprets the center mouse button input signal of the expanded use conventional computer mouse 45 as a particular expanded function modifier, and transmits the appropriate signal to the combined mouse output port 44.

The right mouse button and expanded button logic 51 reads right mouse button or expanded right mouse button input from the primary mouse input port 42 and the secondary mouse input port 43, then processes it along with any relevant input from the other various logic circuits 46-51, and sends the resultant signal as an output to the combined mouse output port 44. In redundant mode, the right mouse button and expanded button logic 51 simply sums the two right mouse button signals to produce the combined output signal. In expanded mode, the right mouse button signal from the primary mouse input port 42 or the right mouse button signal from the secondary mouse input port 43 or both will be used to represent some other expanded function. Typically, expanded right mouse button input will cause some kind of alteration to the performance of the expanded cursor and scroll inputs from the expanded conventional computer mouse 45. For instance, the expanded use conventional computer mouse 45 might pan up/down or left/right when its right mouse button is not depressed and might zoom in/out when its right mouse button is depressed. Or pressing the right mouse button could toggle the user thru a series of modes, such as single cursor/multiple cursor. In this case, right mouse button and expanded button logic 51 interprets the right mouse button input signal of the expanded use conventional computer mouse 45 as a particular expanded function modifier, and transmits the appropriate signal to the combined mouse output port 44.

By selecting various settings on the ratio knob 54, the user can speed up or slow down cursor movements received from the secondary mouse input port 43 relative to the cursor movements received from the primary mouse input port 42. This allows the user to independently adjust the cursor speed on each conventional computer mouse 45. The basic function of the electronic modular adaptor 53 is to combine the signals coming from a conventional computer mouse 45 with those signals from another conventional computer mouse 45 into one signal representing the motion of a single cursor on the screen of a computer 57.

By selecting various settings on the function knob 55, the user can alter the function of the conventional computer mouse 45 connected to the primary mouse input port 42, or the secondary mouse input port 43, or both. One setting will allow a conventional computer mouse 45 to function as a cursor pointing device while a second conventional computer mouse 45 will function as a redundant cursor pointing device with a speed adjustable by the ratio knob 54, another will allow the second mouse to achieve 2-dimensional scrolling and zoom functions, another will scale and stretch objects and perform various object manipulation techniques based on cursor motion and mouse button activation. A system in accordance with the present invention provides the user with many advantageous features, such as the ability to move a cursor, to pan and zoom, to scale and stretch an object, to rotate an object left/right, or to move forward/backward thru a sequence of frames displayed by an application window, or to utilize programmable macro inputs including the use of multiple cursors.

From the foregoing description those skilled in the art will appreciate that all objects of the present invention are realized. A foot actuated computer mouse adaptor 52 and an electronic modular adaptor 53 have been shown and described which permit a computer user to use a conventional computer mouse 45 via the movement of a single foot while simultaneously allowing use of one or more additional conventional computer mice 45 via the movement of the hand, foot, or other appendage. The electronic modular adaptor 53 of this invention is capable of allowing two or more conventional computer mice 45 to be used simultaneously to control a single cursor, and of adjusting the functionality of each conventional computer mouse 45. The foot actuated computer mouse adaptor 52 of this invention is capable of allowing a conventional computer mouse 45 to be installed easily within its housing cavity and removed easily if necessary. The present invention does not force the user to abandon his or her hand actuated mouse, but offers the advantage of allowing a choice. The preferred design of the present invention, as well as alterations that will now be apparent to those skilled in the art, all allow use of the foot actuated computer mouse adaptor 52 and electronic modular adaptor 53 with any number of conventional computer mice 45.

Having described the invention in detail, those skilled in the art will appreciate that modifications may be made of the invention without departing from its spirit. Therefore, it is not intended that the scope of the invention be limited to the specific embodiments illustrated and described. Rather it is intended that the scope of this invention be determined by the appended claims and their equivalents.

I claim:

1. A foot actuated computer mouse adaptor for operating a conventional computer mouse compromising:
a housing having a top surface, a bottom surface, a right side, a left side, a front, a back, and a cavity within said bottom surface;
said cavity having one or more walls and sized to substantially surround the conventional computer mouse except for the base and the top of the conventional computer mouse;
a means for removably holding and positioning the conventional computer mouse within said cavity whereby the base of the conventional computer mouse remains substantially flush with said bottom surface of said housing;
a means for releasably holding the computer user's foot onto said housing whereby the computer user's foot movements correspond to substantially equivalent movements of the conventional computer mouse when said bottom surface of said housing is placed on a substantially flat surface;
a plurality of rotatably adjustable lever means for actuating the buttons on a conventional computer mouse; and
a means for bearing the load of the user's foot without allowing said plurality of said lever means to be actuated while the user's foot is in a resting position.

2. A foot actuated computer mouse adaptor for operating a conventional computer mouse as defined in claim 1, said means for removably holding and positioning the conventional computer mouse within said cavity compromising:
a plurality of adhesive strips that secure the conventional computer mouse to said housing; and
a free floating or hinged mechanical lever that bears down on the conventional computer mouse with a fraction of the user's weight to keep the conventional computer mouse substantially flush with said bottom surface of said housing.

3. A foot actuated computer mouse adaptor for operating a conventional computer mouse as defined in claim 1, said means for removably holding and positioning the conventional computer mouse within said cavity compromising:
one or more foam inserts capable of frictionally fitting between said one or more walls of said cavity and the conventional computer mouse; and
a free floating or hinged mechanical lever that bears down on the conventional computer mouse with a fraction of the user's weight to keep the conventional computer mouse substantially flush with said bottom surface of said housing.

4. A foot actuated computer mouse adaptor for operating a conventional computer mouse as defined in claim 1, said means for removably holding and positioning the conventional computer mouse within said cavity replaced by a means for permanently holding and positioning the conventional computer mouse within said cavity compromising:
fusing the conventional computer mouse to said one or more walls of said cavity using an adhesive; and
a free floating or hinged mechanical lever that bears down on the conventional computer mouse with a fraction of the user's weight to keep the conventional computer mouse substantially flush with said bottom surface of said housing.

5. A foot actuated computer mouse adaptor for operating a conventional computer mouse as defined in claim 1, said means for removably holding and positioning the conventional computer mouse within said cavity replaced by a means for permanently holding and positioning the conventional computer mouse within said cavity compromising:
fusing the conventional computer mouse to said one or more walls of said cavity by fabricating the conventional computer mouse and said housing as a single piece; and
a free floating or hinged mechanical lever that bears down on the conventional computer mouse with a fraction of the user's weight to keep the conventional computer mouse substantially flush with said bottom surface of said housing.

6. A foot actuated computer mouse adaptor for operating a conventional computer mouse as defined in claim 1, said means for releasable holding the computer user's foot onto said housing compromising:
a plurality of notches integrally formed into said right side of said housing and said left side of said housing;
a heel strap placed thru said notches and behind the user's heel; and
a foot strap optionally placed thru said notches an over the user's foot.

7. A foot actuated computer mouse adaptor for operating a conventional computer mouse as defined in claim 1, said means for releasable holding the computer user's foot onto said housing compromising:
a sandal or shoe formed integrally with said housing.

8. A foot actuated computer mouse adaptor for operating a conventional computer mouse as defined in claim 1, said plurality of lever means each being individually adjustable for height with one or more adjustment screws.

9. An electronic modular adaptor compromising:
a housing having an inside and an outside;
said outside having a plurality of input ports each configured to accept signals from a conventional computer mouse or other source;
said outside having one or more output ports configured to transmit conventional computer mouse signals or other signals to a computer or other electronic device;
said outside having a plurality of adjustment means whereby the user can alter the functionality of one or more conventional computer mouse or other source signals received at said input ports; and
said inside having a plurality of logic circuits capable of relaying a conventional computer mouse or other signal to said output port or ports in response to the settings of said plurality of adjustment means and said signals received at said plurality of input ports.

10. An electronic modular adaptor as defined in claim 9, said plurality of input ports and said output port compromising PS/2 connectors.

11. An electronic modular adaptor as defined in claim 9, said plurality of input ports and said output port compromising USB connectors.

12. An electronic modular adaptor as defined in claim 9, said plurality of input ports and said output port compromising serial connectors.

13. An electronic modular adaptor as defined in claim 9, said plurality of input ports and said output port compromising wireless receivers and transmitter.

14. An electronic modular adaptor as defined in claim 9, said plurality of input ports and said output port compromising a collection of one or more types of the following connectors: PS/2 connectors, USB connectors, serial connectors, electric guitar patchcord connectors, and wireless receivers and transmitter.

15. One or more foot actuated computer mouse adaptors each used for operating a conventional computer mouse used in conjunction with one or more electronic modular adaptors, said foot actuated computer mouse adaptor compromising:
a housing having a top surface, a bottom surface, a right side, a left side, a front, a back, and a cavity within said bottom surface;
said cavity having one or more walls and sized to substantially surround the conventional computer mouse except for the base and the top of the conventional computer mouse;
a means for removably holding and positioning the conventional computer mouse within said cavity whereby the base of the conventional computer mouse remains substantially flush with said bottom surface of said housing;
a means for releasably holding the computer user's foot onto said housing whereby the computer user's foot movements correspond to substantially equivalent movements of the conventional computer mouse when said bottom surface of said housing is placed on a substantially flat surface;
a plurality of lever means for actuating the buttons on a conventional computer mouse; and
a means for bearing the load of the user's foot without allowing said plurality of said lever means to be actuated while the user's foot is in a resting position;
and said one or more electronic modular adaptors compromising:
a housing having an inside and an outside;
said outside having a plurality of input ports each configured to accept signals from a conventional computer mouse or other source;
said outside having one or more output ports configured to transmit conventional computer mouse signals or other signals to a computer or other electronic device;
said outside having a plurality of adjustment means whereby the user can alter the functionality of one or more conventional computer mouse or other source signals received at said input ports; and
said inside having a plurality of logic circuits capable of relaying a conventional computer mouse or other signal to said output port or ports in response to the settings of said plurality of adjustment means and said signals received at said plurality of input ports.

16. One or more foot actuated computer mouse adaptors each used for operating a conventional computer mouse used in conjunction with one or more electronic modular adaptors as defined in claim 15, said means for removably holding and positioning the conventional computer mouse within said cavity compromising:
a plurality of adhesive strips that secure the conventional computer mouse to said housing; and
a free floating or hinged mechanical lever that bears down on the conventional computer mouse with a fraction of the user's weight to keep the conventional computer mouse substantially flush with said bottom surface of said housing; and
said means for releasable holding the computer user's foot onto said housing compromising:
a plurality of notches integrally formed into said right side of said housing and said left side of said housing;
a heel strap placed thru said notches and behind the user's heel; and
a foot strap optionally placed thru said notches an over the user's foot.

17. One or more foot actuated computer mouse adaptors each used for operating a conventional computer mouse used in conjunction with one or more electronic modular adaptors as defined in claim 15, said means for removably holding and positioning the conventional computer mouse within said cavity replaced by a means for permanently holding and positioning the conventional computer mouse within said cavity compromising:
fusing the conventional computer mouse to said one or more walls of said cavity by fabricating the conventional computer mouse and said housing as a single piece; and
a free floating or hinged mechanical lever that bears down on the conventional computer mouse with a fraction of the user's weight to keep the conventional computer mouse substantially flush with said bottom surface of said housing; and
said means for releasable holding the computer user's foot onto said housing compromising:
a plurality of notches integrally formed into said right side of said housing and said left side of said housing;
a heel strap placed thru said notches and behind the user's heel; and
a foot strap optionally placed thru said notches an over the user's foot.

18. One or more foot actuated computer mouse adaptors each used for operating a conventional computer mouse used in conjunction with one or more electronic modular adaptors as defined in claim 15, said plurality of input ports and said output port compromising a collection of one or more types of the following connectors: PS/2 connectors, USB connectors, serial connectors, electric guitar patchcord connectors, and wireless receivers and transmitters.

19. One or more foot actuated computer mouse adaptors each used for operating a conventional computer mouse used in conjunction with one or more electronic modular adaptors as defined in claim 15, said plurality of input ports and said output port compromising:
a collection of one or more types of the following connectors: PS/2 connectors, USB connectors, serial connectors, electric guitar patchcord connectors, and wireless receivers and transmitters; and
said means for removably holding and positioning the conventional computer mouse within said cavity compromising:
a plurality of adhesive strips that secure the conventional computer mouse to said housing; and
a free floating or hinged mechanical lever that bears down on the conventional computer mouse with a fraction of the user's weight to keep the conventional computer mouse substantially flush with said bottom surface of said housing; and
said means for releasable holding the computer user's foot onto said housing compromising:
a plurality of notches integrally formed into said right side of said housing and said left side of said housing;
a heel strap placed thru said notches and behind the user's heel; and
a foot strap optionally placed thru said notches an over the user's foot.

20. One or more foot actuated computer mouse adaptors each used for operating a conventional computer mouse used in conjunction with one or more electronic modular adaptors as defined in claim 15, said plurality of input ports and said output port compromising:
a collection of one or more types of the following connectors: PS/2 connectors, USB connectors, serial connectors, electric guitar patchcord connectors, and wireless receivers and transmitters; and
said means for removably holding and positioning the conventional computer mouse within said cavity replaced by a means for permanently holding and positioning the conventional computer mouse within said cavity compromising:
fusing the conventional computer mouse to said one or more walls of said cavity by fabricating the conventional computer mouse and said housing as a single piece; and
a free floating or hinged mechanical lever that bears down on the conventional computer mouse with a fraction of the user's weight to keep the conventional computer mouse substantially flush with said bottom surface of said housing; and
said means for releasable holding the computer user's foot onto said housing compromising:
a plurality of notches integrally formed into said right side of said housing and said left side of said housing;
a heel strap placed thru said notches and behind the user's heel; and
a foot strap optionally placed thru said notches an over the user's foot.
